(19) United States
(12) Patent Application Publication
(10) Pub. No.: US 2007/0256134 A1
(43) Pub. Date: Nov. 1, 2007

(54) Confirming user rights of application program

(75) Inventors: Arto Lehtonen, Kangasala (FI); Tuomas Hakala, Tampere (FI)

Correspondence Address: BUCHANAN, INGERSOLL & ROONEY PC, POST OFFICE BOX 1404, ALEXANDRIA, VA, 22313-1404, US

(73) Assignee: OPENBIT OY, Tampere (FI)

(21) Appl. No.: 11/399,394

(22) Filed: Apr. 7, 2006

(30) Foreign Application Priority Data
Oct. 10, 2003 (FI) 20031482

(51) Int. Cl. G06F 7/04

(52) U.S. Cl. 726/26

(57) ABSTRACT

A method for confirming a licence for an application program downloadable into a terminal device, a software product implementing the method, and a terminal device. An application program without a confirmed licence is downloaded into a terminal device having a camera operationally connected thereto. In response to the activation of the application program, an application managing application program licences is also activated. On the terminal device display, at least one alternative for making a payment for the licence is presented to the user. When the user selects a payment card, an image file of the card is created. From the image file, payment card identifier data are determined and, in response to a successful determining of the identifier data, a licence is received from licence management functionality to confirm the right to use the application program in the terminal.

### FIELD OF THE INVENTION

The invention relates to distributing application programs, and particularly to confirming user rights for an application program downloadable into a terminal device.

### BACKGROUND OF THE INVENTION

An ever-increasing part of software development is associated with application programs developed onto various generally known and widely used platforms. A platform typically comprises basic hardware entities belonging to a given hardware environment and basic software acting as the operating system. In case of an open platform, the configuration data of the hardware, the operating system software, and the essential interfaces are accessible to anyone, allowing also third parties to develop the application programs. Various open platforms are widely used both in computers and in devices closely related thereto, such as mobile stations. Open platforms include for instance Java™, which is a purely software-based platform for use in both computers and mobile stations, and Symbian, which is designed for use particularly in a mobile communication environment.

Open platforms are operating environments advantageous to a software developer acting as a third party, since the devices using them are typically widely spread and generally used, i.e. the number of potential application program clients is also large. Typically, a software developer is able to offer his products for sale either directly or via a distribution company. An application program purchased by a client is loaded and installed into the client's terminal, wherein the program code comprised by the application program is run on the platform.

Typically, the right to use an application program is admitted by a licence in response to the payment made by a client. Various payment cards, such as credit and back cards, are today generally accepted means of payment in connection with electronic commerce. Payment cards are used in the Internet typically by entering the card's identifier number, and in some applications also a password, in the appropriate fields. The payment card data is then transmitted to the party providing the application programs, and the card owner can thus be charged afterwards.

However, the transmission of payment card data involves a considerable security risk, because it is possible that unauthorized parties gain access to the data during the transmission. An outside person who has the data at his disposal may misuse the data for example by using the card for major purchases even in a short time, the invoices being naturally charged to the owner of the card. Another problem in paying the licence is that the entering of the payment card data is time-consuming, because the entered data must be perfectly accurate.

### BRIEF DESCRIPTION OF THE INVENTION

It is therefore an object of the invention to provide an arrangement in which the drawbacks caused by the above problems can be alleviated. The object of the invention is achieved by a method, software product, and a terminal device characterized by what is stated in the independent claims. The preferred embodiments of the invention are disclosed in the dependent claims.

The basic idea of the invention is that at least one application program without a confirmed licence is downloaded into a terminal device. The terminal device is arranged to set up a data transfer connection to a processing unit comprising licence management functionality. In response to the activation of the application program in the terminal, an application managing application program licences is also activated in the terminal. On the display of the terminal, at least one option for the method of payment of the licence is shown to the user. In response to the user's decision to select a payment card, an image file of the card to be used is created in the terminal that has a camera operationally connected thereto. On the basis of the image file, the identifier data of the payment card are determined. In response to a successful debit operation, a licence is received from the licence management functionality to confirm the right to use the application program in the terminal.

According to a preferred embodiment of the invention, the image file of the payment card to be used is sent to the processing unit, together with at least one of the following data: application program identifier, terminal device identifier (e.g. the IMEI code of a terminal device), user identifier (e.g. the IMSI code of a SIM card), and a request for a licence.

According to a preferred embodiment of the invention, the payment card identifier data are determined from the image file by means of optical character recognition.

According to a preferred embodiment of the invention, an application program is downloaded into the terminal and the activation of the application program is allowed in response to the payment of the program licence fee by means of a payment card.

According to a preferred embodiment the payment card identifier data are transmitted further to a billing unit, such as a bank or a credit card company, which charges the owner of the card for the goods and services.

According to a preferred embodiment of the invention the user is requested to enter the password of the payment card to be used into the terminal device, the password being used for creating a password file, which is then transmitted to the processing unit.

The arrangement of the invention provides significant advantages. One of them is that the arrangement provides a method of payment of increased safety, because the payment card cannot be misused on the basis of the identifier number and the password alone, but when making the payment, the payer must have the card so that it can be photographed. Another advantage is that because of its clarity and the fact that it requires only minor hardware investment, the arrangement of the invention is relatively easy and affordable to implement and to maintain. A further advantage is that the arrangement of the invention provides the user of the terminal device with a convenient and rapid means to purchase application programs, typically wherever and whenever.

### BRIEF DESCRIPTION OF THE DRAWINGS

In the following the invention will be described in greater detail with reference to preferred embodiments and the accompanying drawings, in which

FIG. 1 illustrates a wireless terminal device in which the invention can be applied;

FIG. 2 illustrates the structure of a payment card and its identifier data;

FIGS. 3a and 3b illustrate signalling diagrams of methods according to some preferred embodiments of the invention; and

FIG. 4 illustrates a signalling diagram of a method according to a preferred embodiment of the invention.

### DETAILED DESCRIPTION OF THE INVENTION

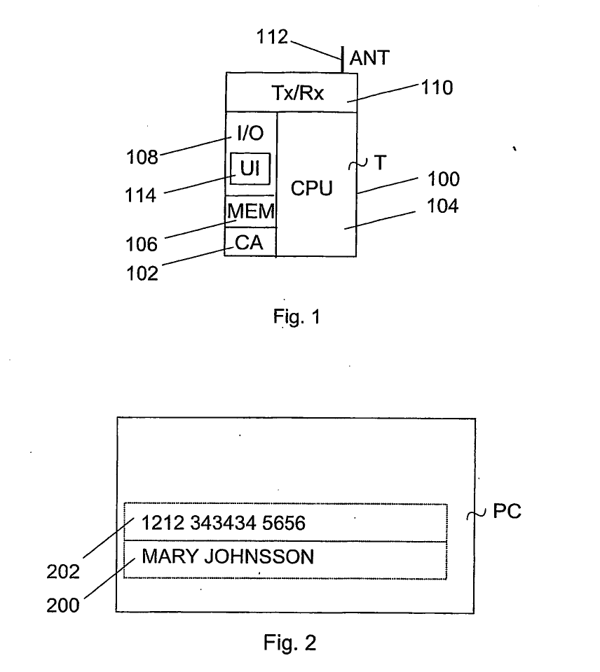

FIG. 1 shows a wireless terminal device T (100) with camera functionality CA (102) connected thereto. In this context the wireless terminal refers generally to a device comprising means needed for implementing wireless data transfer. These devices include equipment capable of data communication with a PLMN network, such as the GSM/GPRS network, or with third generation systems, such as the 3GPP system. The invention can also be applied in terminal devices provided with a camera that is not integrated into the device but provides image data through a wired or wireless connection with the terminal device.

The wireless terminal device T (100) comprises a Central Processing Unit CPU, which in turn comprises one or more processors, memory MEM (106), I/O system I/O (108), and transceiver Tx/Rx (110) arranged to transmit and receive data transfer conforming to different wireless data transfer protocols via an antenna ANT (112). The necessary data are stored in the terminal device memory MEM (106), which typically comprises Read Only Memory capacity, such as ROM, for storing applications controlling the central processing unit CPU (104) and other data that are to be kept in storage, and write memory capacity, such as RAM (Random Access Memory) and/or FLASH memory for temporary data processing. Through the I/O system I/O (108), the terminal T (100) communicates outward, for example with other terminal devices, the network and, the user. A user interface UI (114), which is part of the I/O system I/O (108) may comprise a user interface, such as display, keyboard, loudspeaker, and microphone, for example, through which the terminal device and the user may communicate with each other. The data received from the different components of the terminal device T (100) are transmitted to the central processing unit CPU (104), which processes the information it receives. The operation of the camera CA (102) connected to the terminal device T (100) may be based on any known digital photography technology and the camera may convert light to electrical charges in an image sensor, determine RGB values for pixels, and convert them to a digital format. It is to be noted that in addition to what are known as still frames, the camera CA (102) may be able to store video as well. Digital image data is processed, for example compressed, and stored into the memory MEM (106) by the central processing unit CPU (104).

FIG. 2 shows the structure of a widely used payment card PC and its identifier data. The payment card typically comprises the name 200 of the cardholder and the card number 202, which according to a preferred embodiment of the invention are arranged to be photographed in manner to be disclosed below.

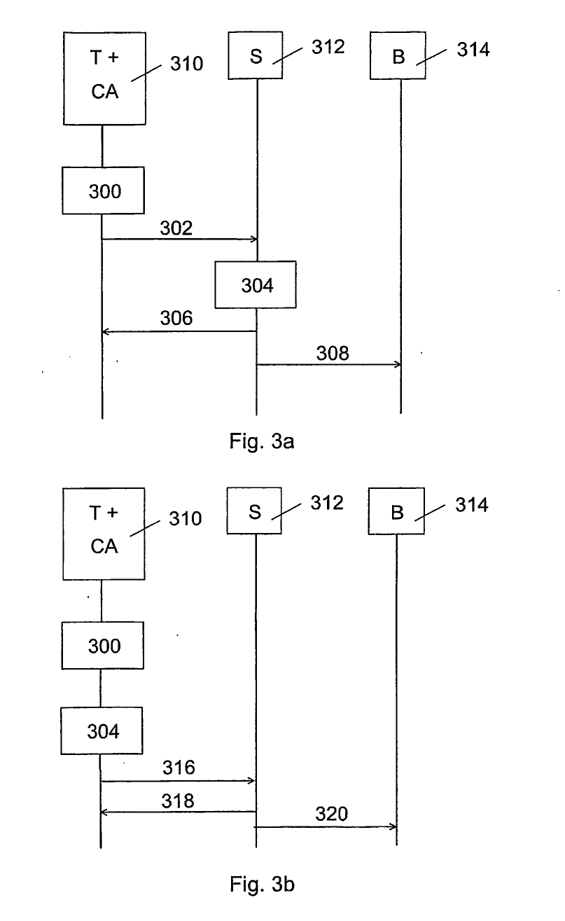

The signalling diagrams of FIGS. 3a and 3b illustrate methods according to some preferred embodiments of the invention for processing payment transaction data. In the Figures, like numbers refer to like parts. According to the signalling diagram of FIG. 3a, the client uses a terminal device T (310) and a camera CA operationally connected thereto. The terminal device T (310) and the camera CA may preferably be integrated to form what is known as a camera phone. A service provider, in turn, manages a server S (312) that receives and processes payments transactions transferred as payments forservices. The client becomes liable to pay for example when s/he wishes to purchase a service, such as a licence for an application program from the service provider. According to the invention the payment is made by photographing the payment card and the identifier data it contains with the camera CA operationally connected to the terminal device T (310), for example with the camera of a camera phone. To allow the payment transaction to be verified, it is essential that the picture comprises at least the number of the payment card and preferably also the name of the cardholder. An image file (300) created on the basis of the picture is transmitted (302) over a data transfer connection set up by the terminal device T (310) to the server A (312) processing payment transaction data. At the server S (312) the payment card identifier data (304) are determined on the basis of the image file (300) for example by means of Optical Character Recognition OCR included in the server S (312). In response to successful determining of the identifier data, the server S (312) preferably sends an acknowledgement (306) to the terminal device T (310) to confirm that payment has taken place. At some point the payment card identifier data are then sent (308) further to a billing unit B (314), which charges the owner of the card afterwards for the goods and services.

According to the signalling diagram of FIG. 3b, in order to carry out the payment transaction, the payment card and the identifier data contained therein, for example at least the number of the card and preferably also the name of the cardholder, are photographed with the camera CA operationally connected to the terminal device T (310). The terminal device T (310) creates an image file (300) of the picture, the file being then used for determining the payment card identifier data (304) by using for example the optical character recognition included in the terminal device T (310). The terminal device T (310) preferably acknowledges that the identifier data have been successfully determined and the determined identifier data (304) are then transmitted (316) over a data transfer connection set up by the terminal device T (310) to a server S (312) processing payment transaction data. In response to the successful determining of the identifier data, the server S (312) preferably sends an acknowledgement (318) to the terminal device T (310) for the payment transaction. At some point, the identifier data (304) of the payment card are then transmitted (320) further to a billing unit B (314), which charges the payment card owner afterwards for the goods and services.

Optical character recognition OCR can be used for recognising digits from digital pictures by means of computer arithmetics. There are various ways for carrying out the digit recognition, but according to a preferred embodiments interference is first filtered from the picture and the quality of the picture is improved to enable digit recognition. As a result of this pre-processing the picture preferably occupies less memory space, and the digits are easier to find from the picture. The digits are found using what is known as a segmentation method, which is followed by counting numerical characteristics from the segmented digits. The segmented digits are classified according to the counted characteristics by using a classification algorithm. Typically the classification is carried out using neural networks, such as those known as Multi-Layer Perception networks MLP. Post-processing and ad-hoc logic may be employed to further improve the recognition results. Post-processing is typically application-dependent.

According to a preferred embodiment of the invention, when the client pays for goods or services, the payment card and the identifier data contained therein are photographed with the camera operationally connected to the terminal device. In addition, the payment card password is entered into the terminal device. Thus a stolen card cannot be used by an unauthorized person, for example, who does not known the password of the payment card. Both the image file created on the basis of the picture and the password file based on the password are transmitted over a data transfer connection set up by the terminal device to the server managed by the provider of the goods or services that processes payment transaction data. At the server, the identifier data of the payment card are determined from the image and password files by means of optical character recognition, for example. The identifier data are thus ready to be forwarded for billing.

The payment transaction method of the invention is naturally most suitable for paying for services and products, such as different application programs, to be used in connection with camera phones. One example of this type of application program is Photographer™, which is available for specific wireless terminal devices. The program offers for example photograph, zoom and panorama functionalities that can be used for improving the quality of pictures taken with camera phones, for example. The licence management application included in the application program Photographer™ allows the application program to be distributed from one user to another over a wireless connection, such as a Bluetooth or an infrared connection, or over the Internet. In that case a new user of the application program can be offered a licence that can be acknowledged as paid for by applying the payment transaction method described above.

In the following, an example of the application of the payment method described above in connection with a licence management application included in the application program Photographer™ is described. In this example application programs are distributed and licences managed using a distribution model known per se, in which model the terminal devices using application programs and the server managing application program licences comprise what is known as a licence management functionality the structure of which is divided into what is known as client/server.

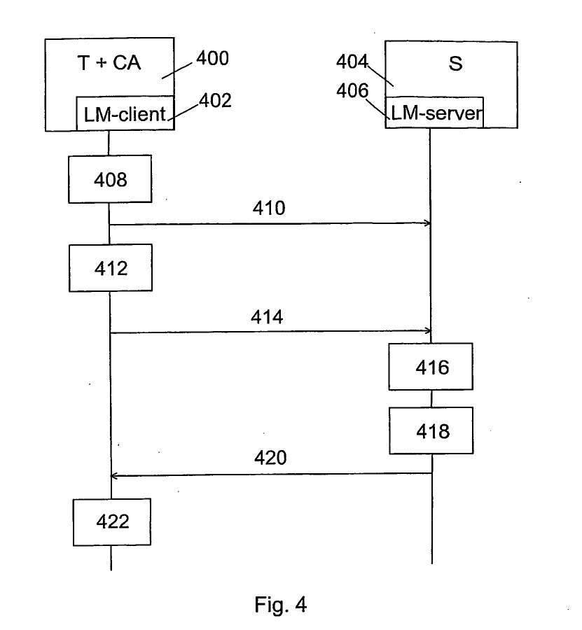

FIG. 4 shows a signalling diagram of a method according to a preferred embodiment of the invention. A terminal T (400), provided with a camera CA operationally connected thereto, comprises dedicated licence management functionality LM_client (402), which communicates with licence management functionality LM_server (406) residing on a server S (404). In the signalling diagram of FIG. 4, data transfer between the licence management functionality LM_client (402) of the terminal device T (400) and the licence management functionality LM_server (406) of the server S (404) has been arranged, by way of example, to take place by means of a short message service (SMS). It is apparent that the data transfer can be carried out using any method known per se.

The activation of the application program, such as the application program Photographer™, downloaded into the terminal device T (400) activates also the licence management functionality, which can be advantageously implemented as a licence management program run at the background in the terminal, the program monitoring the user rights of other application programs.

First the licence management program LM_client (402) checks whether the activated application program has a valid licence. If it has, the licence has been registered either during a previous use of the application or at the time the application program was purchased, for example. If the application program has a valid licence, the licence management program LM_client (402) of the terminal device T (400) sends the licence management server S (404) a message comprising a licence code (LC), application program identifier (Appl_ID), terminal device identifier (T_ID), and user identifier (User_ID). The use of the application program can then be continued as usually.

If there is no valid licence, the licence management program LM_client (402) asks the user of the terminal device T (400) to enter the licence code LC of the downloaded application program. This kind of situation may arise for example when a downloaded application program is taken in use for the first time and the licence code LC has been delivered to the user of the terminal device T (400) separate from the application program, in which case the licence code LC serves to confirm that the payments set for the program have been settled. The licence management program compares the entered licence code with the identifier data included in the application program and if the licence code LC entered by the user is correct, the licence is registered as valid and the use of the application program may be continued as usually.

When the licence management program LM_client (402) is checking whether the activated application program has a valid licence (408), and if the user does not know the licence code LC of the application program, which may be the case for example in the situation described above, where the application program is copied from one terminal to another, the licence management functionality offers the user a possibility to buy a licence. The user may be offered either a full licence or a temporary licence of 30 days, for example, for the use of the application program. In connection with this, a window is preferably opened on the display to preferably determine the prices of different licence alternatives. After having selected the licence alternative of his/her preference, the user may choose the method of payment; i.e. decide whether to use a payment card or to have the payment added to what is known as a cash routine included in the licence management program, the payment being then made by debiting the routine afterwards in smaller installments. The licence management program LM_client (402) of the terminal device T (400) sends the server S (404) a message (410) comprising the application program identifier (Appl_ID), the terminal device (T 400) identifier (T_ID), and the user identifier (User_ID) as well as a request for a full licence or a temporary one.

If the user chooses to pay by payment card, the above described payment method is applied and the licence management program LM_client (402) requests the user of the terminal device T (400) to photograph the payment card to be used with a camera phone so that the number of the card and preferably the name of the cardholder are shown in the picture. When the user of the terminal device has taken the picture and checked that the identifier data are visible, the user acknowledges that the picture has been taken, and, consequently, an image file (412) is sent (414) to the server S (404) maintained by the supplier of the application program, for example, for processing.

The payment card identifier data (416) are determined from the image file at the server S (404) for example by means of an optical character recognition application residing on the server S (404). The licence management program of the server LM_Server determines a new licence code LC (418) for the application program and stores a combination of the licence code LC (418), the application program identifier, the terminal device identifier, and the user identifier into a database. In response to a successful determining of the identifier data (416) and the licence code (418), the server S (404) preferably sends and acknowledgement (420) to the terminal device to inform that payment has taken place and transmits, at the same time, the determined licence code LC (418), in response to which the licence management program LM_client (402) accepts the licence as acknowledged and allows the application program to be activated (422). The server S (404) can then transmit the payment card identifier data further to a billing unit, such as a bank or a credit card company, which charges the card owner afterwards by a sum corresponding to the licence payment.

According to a preferred embodiment the payment card identifier data are determined in the terminal device T (400) by means of the optical character recognition included in the terminal device T (400), for example, the identifier data being then transmitted to the server S (404) whose licence management program LM_server (406) determines a new licence code LC for the application program and stores a combination of the licence code LC, the application program identifier, the terminal device identifier, and the user identifier into a database. In response to a successful determining of the identifier data and the licence code, the server S (404) preferably sends an acknowledgement (420) to the terminal device to inform that a payment has taken place and transmits, at the same time, the determined licence code LC (418), in response to which the licence management program LM_client (402) accepts the licence as acknowledged and allows the application program to be activated (422). The server S (404) can then send the payment card identifier data further to a billing unit, such as a bank or a credit card company, which charges the payment card owner afterwards by a sum corresponding to the licence payment.

Since this kind of payment transaction method increases the safety of a payment card as a means of payment for a licence fee, it encourages the user to make the licence payment immediately, instead of entering the payment to a cash routine included in the licence management program for debiting taking place later in smaller installments. This kind of payment transaction method is advantageous for the application program supplier as well, because the client is more encouraged than before to make the licence fee payment immediately. It is also possible that the application program supplier offers the payment card alternative for the payment of a full licence only, whereas a temporary licence is to be debited from a cash routine and thus, because of the payment transaction method of the invention, the client may be more inclined than before to buy a full licence immediately. The method of the invention for processing payment transaction data can be implemented by means of a computer software product to be executed on a terminal device that has a camera operationally attached thereto. The computer software product comprises a program code for setting up a data transfer connection from the terminal device to a processing unit (312) comprising licence management functionality. The computer software further comprises: a program code for activating an application managing application program licences in the terminal device (310), a program code for displaying to the user at least one alternative for making a payment for the licence, a program code for creating an image file from the payment card to be used, and a program code for receiving the licence from the licence management functionality, the licence confirming the right to use the application program in the terminal device (310). According to a preferred embodiment the computer software product further comprises a program code for determining payment card identifier data from an image file and a program code for transmitting an image file to the processing unit over a data transfer connection.

It is apparent to a person skilled in the art that as technology advances, the basic idea of the invention can be implemented in various ways.

The invention and its embodiments are therefore not restricted to the above examples, but they may vary within the scope of the accompanying claims.

1. A method for confirming a licence for an application program downloadable into a terminal device, in which method at least one application program without a confirmed licence is downloaded into the terminal device, the terminal device, provided with a camera operationally connected thereto, being configured to set up a data transfer connection to a processing unit comprising licence management functionality, wherein
in response to the activation of the application program in the terminal device, an application managing application program licences is activated in the terminal device;
at least one alternative for making the payment for the licence is shown to the user on the display of the terminal device;
in response to the user choosing a payment card as the method of payment, an image file of the card to be used is created in the terminal device;
determining payment card identifier data from the image file; and
in response to a successful determining of the identifier data, the licence is received from the licence management functionality to confirm the right to use the application program in the terminal device.

2. A method according to claim 1, further comprising
transmitting the image file to the processing unit over said connection.

3. A method according to claim 1, further comprising
determining the payment card identifier data from the image file in the terminal device; and
transmitting the identifier data to the processing unit over said connection.

4. A method according to claim 1, further comprising
transmitting to the processing unit at least one of the following data:
an application program identifier;
an identifier of the terminal device;
a user identifier of a subscriber connection;
a request for a licence.

5. A method according to claim 1, further comprising
determining the identifier data of the payment card from the image file by means of optical character recognition.

6. A method according to claim 1, further comprising
downloading the application program into the terminal device; and
allowing the application program to be activated in response to the payment for the licence fee of the application program having been settled with the payment card.

7. A method according to claim 1, further comprising
requesting the user of the terminal device to enter the payment card password into the terminal device;
creating a password file from the password; and
transmitting the password file to the processing unit over the connection.

8. A method according to claim 1, further comprising
requesting the user of the terminal device to enter the password of the payment card into the terminal device;
creating a password file from the password;
determining the identifier data from the image file and password file in the terminal device; and
transmitting the identifier data to the processing unit over said connection.

9. A computer software product for confirming a licence for an application program downloadable into a terminal device, the computer software product being configured to be executed in the terminal device, which has a camera operationally connected thereto, the computer software product comprising a program code for downloading into the terminal device at least one application program without a confirmed licence, which computer software product is configured to set up a data transfer connection to a processing unit comprising licence management functionality,
wherein the computer software product comprises:
a program code for activating the application managing application program licences in the terminal device;
a program code for displaying to the user at least one alternative for making the payment for the licence;
a program code for creating an image file from a payment card to be used; and
a program code for receiving the licence from the licence management functionality, the licence code confirming the right to use the application program in the terminal device.

10. A computer software product according to claim 9,
wherein the computer software product comprises
a program code for transmitting the image file to the processing unit over said connection.

11. A computer software product according to claim 9,
wherein the computer software product comprises
a program code for determining the payment card identifier data from the image file; and
a program code for transmitting the identifier data to the processing unit over said connection.

12. A computer software product according to claim 9,
wherein the computer software product comprises
a program code for transmitting to the processing unit at least one of the following data:
an application program identifier;
an identifier of the terminal device;
a user identifier of the subscriber connection;
a request for a licence.

13. A computer software product according to claim 9,
wherein the computer software product comprises
a program code for determining the identifier data from the image file by means of optical character recognition.

14. A computer software product according to claim 9,
wherein the computer software product comprises:
a program code for downloading the application program; and
a program code for activating the application program in response to the payment of the application program licence fee by means of the payment card.

15. A terminal device configured to received at least one application program without a confirmed licence, the terminal device having a camera operationally connected thereto and the terminal device being configured to set up a data transfer connection to a processing unit comprising licence management functionality,
wherein the terminal device comprises:
means for activating the application managing application program licences in the terminal;
means for presenting to the user at least one alternative for making the payment for the licence;
means for creating an image file of the payment card to be used; and
means for receiving a licence from the licence management functionality, the licence confirming the right to use the application program in the terminal device.

16. A terminal device according to claim 15,
wherein the terminal device comprises
means for transmitting the image file to the processing unit over the data transfer connection.

17. A terminal device according to claim 15,
wherein the terminal device comprises:
means for determining the payment card identifier data from the image file; and
means for transmitting the identifier data to the processing unit over said connection.

18. A terminal device according to claim 15,
wherein the terminal device comprises:
means for transmitting to the processing unit at least one of the following data:
an application program identifier;
an identifier of the terminal device;
a user identifier of a subscriber connection;
a request for a licence.

19. A terminal device according to claim 15,
wherein the terminal device comprises
means for determining the identifier data from the image file by means of optical character recognition.

20. A terminal device according to claim 15,
wherein the terminal device comprises:
means for downloading the application program; and
means for activating the application program.
